(19) United States
(12) Patent Application Publication
(10) Pub. No.: US 2025/0289685 A1
(43) Pub. Date: Sep. 18, 2025

(54) UNIVERSAL ELEVATOR

(71) Applicant: THOMA AUFZÜGE GMBH, Frankfurt (DE)

(72) Inventor: Volker Fritz, Frankfurt (DE)

(21) Appl. No.: 18/859,005

(22) PCT Filed: Apr. 20, 2023
(86) PCT No.: PCT/EP2023/000026

§ 371 Date: Oct. 22, 2024

(30) Foreign Application Priority Data
Apr. 25, 2022 (EP) 22000108.5

(51) Int. Cl. B66B 11/00; B66B 7/02; B66B 9/00; B66B 11/02; B66B 13/00; B66B 15/02

(52) U.S. Cl. CPC B66B 11/0005; B66B 7/02; B66B 9/00; B66B 11/0045; B66B 11/0226; B66B 15/02; B66B 13/00

(57) ABSTRACT

A passenger elevator, in particular, a passenger elevator, comprises a car, an inner frame, and an outer frame, wherein the outer frame encloses an elevator shaft and comprises a base plate, a first lateral surface, a second lateral surface lying opposite the first lateral surface, a third lateral surface, and a fourth lateral surface lying opposite the third lateral surface, wherein the inner frame comprises at least one first guide post and a second guide post lying opposite the first guide post, characterized in that the inner frame supports the weight of the car.

### FIELD OF THE INVENTION

The present invention relates to an elevator, in particular a passenger elevator. The inventive elevator is particularly well suited for use in various elevator shafts, in particular elevator shafts made of concrete or also lightweight elevator shafts, for example made of glass or aluminum. It is also well suited for retrofitting.

### BACKGROUND TO THE INVENTION

As the prior art shows, elevators are typically installed in an elevator shaft, which is part of the building shell.

European patent 921 088 discloses an elevator with a typical elevator shaft. This is cast from concrete and has various access openings on its front side. An elevator car runs in the shaft. At its rear, space is provided for the lifting mechanism and a counterweight. A drive unit is provided at the upper end of the shaft. This drive unit is connected to the shaft wall and is supported by it.

European patent specification 665 181 discloses an open elevator shaft and an elevator car adapted thereto. In particular, such an elevator shaft may be produced with glass panels and a corresponding support frame. This is usually done during the construction of a building.

The Japanese patent application JP 2006151625 A2 discloses an elevator with a compact guide and drive unit. The elevator comprises a car on a square base. The elevator shaft is also square. Guide elements are provided to the left and right of the car. Further drive and guide elements are provided behind the car. This also includes a counterweight, which is guided on the rear wall of the elevator shaft. Overall, the construction appears space-saving. However, the required shaft dimensions are significantly larger than the car dimensions. Only the front area of the shaft, where access doors are also provided, is free of technical components for the drive and guide. On the rear side, the shaft must be considerably larger than the car, and large clearances must also be provided in the shaft to the sides of the car. This elevator is also intended for a shaft provided at the time of construction of the building.

In other cases, the elevator is retrofitted after the building has been constructed. It is common in this case for an elevator shaft to be connected to a building wall.

In both cases, other constructions are typically used inside the respective shaft. The present invention aims to avoid the disadvantages of the prior art and to ensure that an elevator is able to be installed equally well in a prefabricated (concrete) shaft or in a subsequently added shaft.

The present invention therefore aims to provide an elevator construction which is compact and suitable for many shaft types in a simple, economical manner. In particular, the elevator should be suitable both for the initial equipping of a building and for retrofitting. Economic advantages are to be achieved by reducing the load-bearing capacity of the shaft walls and thus saving on building materials.

This object is achieved by an elevator according to claim 1. Advantageous developments are to be found in the dependent claims.

### MORE DETAILED DESCRIPTION

An elevator according to the present invention may be a passenger or freight elevator. It comprises a suitably adapted car. A passenger car will generally comprise at least one car door.

The elevator shall comprise an outer frame that encloses an elevator shaft. It thus forms the outer shell of the elevator shaft and determines its dimensions. The outer frame comprises a base, a ceiling surface, a first lateral surface, a second lateral surface lying opposite the first lateral surface, a third lateral surface, and a fourth lateral surface lying opposite the third lateral surface. In the case of an elevator shaft installed in a shell construction, the base plate will usually be made of stone or concrete. This usually also applies to the lateral walls, which have the aforementioned lateral surfaces. It also applies to the ceiling, which closes off the elevator shaft at the top along the ceiling surface, but is typically provided with ducts.

The elevator shaft may be erected over a rectangular base and may thus have a substantially cuboid shape. This means that it has four lateral walls that correspond to the aforementioned lateral surfaces. Alternatively, other shapes are also possible, for example elevators are sometimes built over the base of an isosceles octagon. In this case, further lateral surfaces are added to the four lateral surfaces mentioned. In the case of a substantially round shaft, the lateral surfaces may also be thought of as circumferential portions on a cylindrical surface.

The outer frame may be part of a building or may be erected independently of the building. A metal structure is often used. In the case of a cuboid elevator shaft, the metal structure typically has four corner posts, which stand on a suitable base plate and are connected by cross struts, at least in the upper region. Such cross struts may also support a ceiling. Depending on the height of the elevator shaft, further cross struts may be required. The walls of the outer frame may be closed off by suitable panels; metal or plastic panels may be used for this purpose. Glass panels are also frequently used.

The elevator should also have an inner frame. The inner frame consists of at least one first guide post and a second guide post lying opposite the first guide post. These posts generally extend in one piece over the entire length of the elevator shaft. However, they may also be made in several pieces. These guide posts are used in particular to guide the elevator. They therefore ensure that the car moves in a fixed position in the elevator shaft, independently of the lifting means. In addition to the two guide posts, the inner frame will generally comprise a cross connection at the upper ends of these posts. This may be a cross strut; the guide posts and cross strut would then form a kind of gate. The cross connection may also be produced by a cover plate.

This inner frame may support the weight of the car. The outer frame may therefore serve to increase the stability of the inner frame and, in particular, prevent the inner frame from tilting about an axis of rotation in the region of the base plate. However, the outer frame does not also have to bear the weight of the car. This represents a significant deviation from a conventional elevator construction. In the context of the present invention, it may be possible for the outer frame to also bear part of the weight of the car, for example 10% or a maximum of 20% of the weight. As a rule, however, the inner frame will bear the entire weight of the elevator for structural reasons alone. In most cases, however, the inner frame is not suitable for providing the elevator without the outer frame. In particular, the outer frame serves to statically support the inner frame, in particular against movements from the vertical. Furthermore, the lateral walls of the outer frame serve to securely separate the elevator from its surroundings. Shaft doors are usually also provided in the outer frame.

It is expedient for the first guide post and the second guide post to be arranged diagonally opposite each other, more specifically at the edge of the base plate. This leaves plenty of space between the guide posts to guide the car. If the lateral surfaces of the outer frame are arranged on a rectangle, the first guide post and the second guide post are usually positioned at opposite corners of this rectangle.

The inner frame may also expediently support the drive unit. The drive unit will usually consist of a motor, often an electric motor, and, if necessary, also a transmission. The drive unit will generally additionally comprise at least one driven wheel. In the context of the present invention, it has proven to be expedient for the drive motor to drive two wheels, each of which is located in corner regions of the outer frame, more specifically expediently in those corner regions in which the guide posts of the inner frame are also arranged.

A particularly expedient construction is achieved if the first guide post and the second guide post are connected by a cross strut. This cross strut may be made in one piece or in several pieces. A one-piece cross strut is quite practical. This results in essence in a three-part inner frame, consisting of the two guide posts and the cross strut. All three components as well as the inner frame as such may be designed in one or more parts.

In particular, the cross strut may also support drive elements. In particular, the motor may be supported by the cross strut and is typically attached to the cross strut for this purpose. A drive shaft may also be provided parallel to the cross strut. This drive shaft may also be mounted on the cross strut. It is expedient if a drive wheel is provided at one end, and it is often even more expedient for the elevator construction according to the invention if a drive wheel is provided in each of the two end regions of the cross strut. An end region of the cross strut is understood to mean the outer quarter or fifth of its length. It is advantageous if the cross strut runs diagonally in the shaft, i.e. in particular on the diagonal of a rectangle or square over which a rectangular shaft has been erected.

Such a construction differs significantly from the prior art. In the prior art, the drive unit is usually arranged on a wider surface, for example on an intermediate floor or the shaft ceiling. Where two drive wheels are used, these are driven by a single electric motor via a redirecting transmission, from which two drive shafts then extend. However, such a construction takes up a lot of space. It is particularly advantageous if only one drive shaft is required and this may then be oriented parallel to the cross strut. A motor may be used for this purpose, preferably also a gearless motor, which is also mounted on or at the cross strut.

If the inner frame supports both the weight of the car and the weight of the drive unit, it is not necessary for the outer frame to carry a heavy load. This allows greater design freedom for the outer frame. In the case of an outer frame made of concrete, concrete (or a comparable building material) may be saved. According to current knowledge, this has considerable ecological advantages. If the outer frame is erected independently of the building, it is also advantageous if it may be dimensioned in such a way that it does not have to carry a heavy load.

It is expedient if the first guide post is connected to the outer frame by at least one spacer element. Typically, a large number of spacer elements are used along the length of the elevator. For example, it may be expedient to use a spacer element at the height of each floor. As a rule, the second guide post is also connected to the outer frame by spacer elements; advantageously, the same spacer elements are used as for the first guide post, usually also at the same height.

Such a spacer element may be formed in such a way that a length of at least 2 cm is bridged, i.e., that the innermost point of the outer frame and the outermost point of the inner frame are 2 cm apart. It may be expedient if this length is 5 cm to 10 cm, it may also be up to 20 cm, but more than 30 cm is generally not necessary. It is also possible for the elevator to use spacer elements of different sizes so that different lengths may be bridged. In this way, irregularities in the outer frame may also be compensated for. It is therefore possible, for example, to combine the inner frame with a large number of finished building shafts and easily compensate for structural defects.

Spacer elements that offer a mechanical connecting element to the outer frame have proven to be particularly useful. These may be constituted by a tenon or a flat piece that may be easily inserted into a groove. A corresponding groove (also continuous across all heights) may be easily provided in the outer frame. Towards the shaft, i.e., oriented towards the guide posts, the spacer elements may expediently provide a mechanical connecting element of a different structure. A mounting plate is well suited. Such a plate may have holes to accommodate screws or bolts.

It has proven to be expedient if the guide posts are provided substantially by T-beams. Such a T-beam is very rigid in itself. The base of the “T” is particularly suitable as a guide (i.e., as a guide rail), while the shoulders of the “T” allow the post to be well secured to the outer frame. In practice, the shoulder side of the “T” is usually connected to the spacer element. (The horizontal line in the typeface indicates the “shoulder side”).

It has proven expedient to manufacture the guide posts substantially from steel. This makes them sufficiently rigid and also able to bear the load of the car and possibly also the drive unit. Correspondingly stable guide posts make it possible to design the outer frame to be lightweight. For example, the outer frame may be made entirely or partially of aluminum. It is particularly expedient if the corner posts of the outer frame are made of aluminum. As a rule, it is sufficient to use four corner posts to produce a light and stable outer frame.

It has also proven to be expedient if at least one post of the outer frame has a groove that is oriented towards the inner frame. If the outer frame is erected on a rectangular surface, it is useful if the groove is oriented in the direction of the rectangle diagonals.

It is expedient for the corner posts to have a square cross-section. This may be selected for at least two or also all corner posts. In the case of such a corner post with a square cross-section, the groove may be provided at a particularly favorable 45-degree angle to the lateral surfaces. The orientation of this groove is then substantially towards the center of the shaft. In addition to this groove, it may be expedient to provide further grooves or fastening elements in the lateral surfaces, i.e. in the direction of the lateral walls.

This groove is then particularly suitable for accommodating the spacer elements by which the inner frame may be connected to the outer frame. However, the groove may also accommodate other guide or control elements.

Further features and also advantages of the invention are to be found in the drawings listed below and in the associated description. In the figures and in the associated descriptions, features of the invention are described in combination. However, these features may also be included in other combinations of a subject matter according to the invention. Each disclosed feature is therefore also to be regarded as disclosed in technically meaningful combinations with other features. Some of the figures are slightly simplified and schematic.

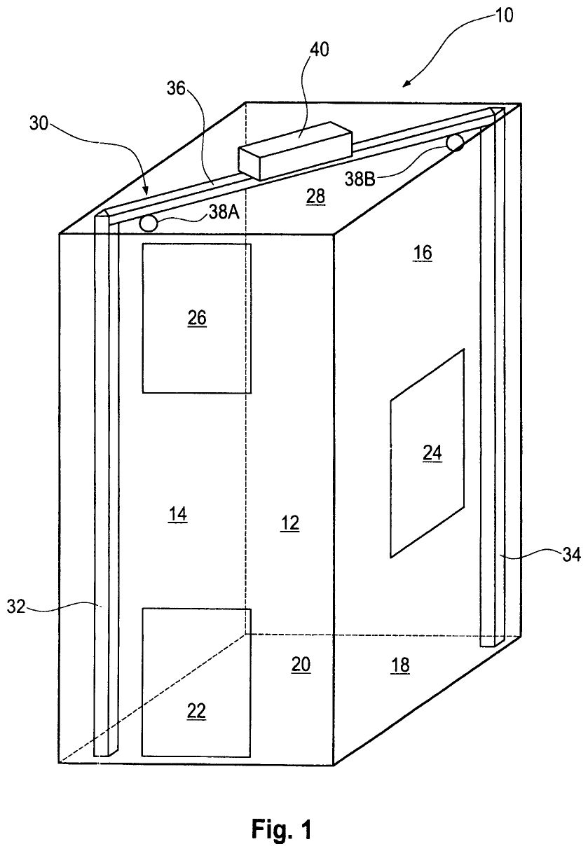

FIG. 1 shows a sketch of a perspective view of an outer frame and inner frame for an elevator according to the invention

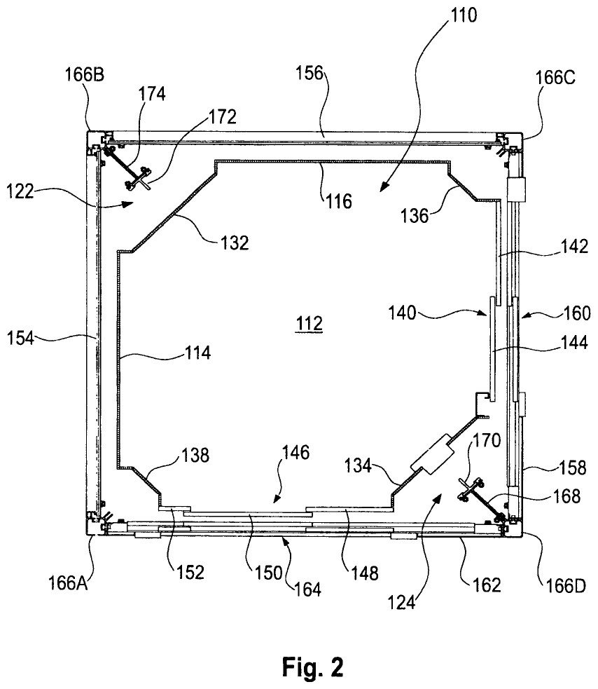

FIG. 2 shows a plan-view cross-section of an inner frame and outer frame according to the invention as well as an elevator car adapted thereto

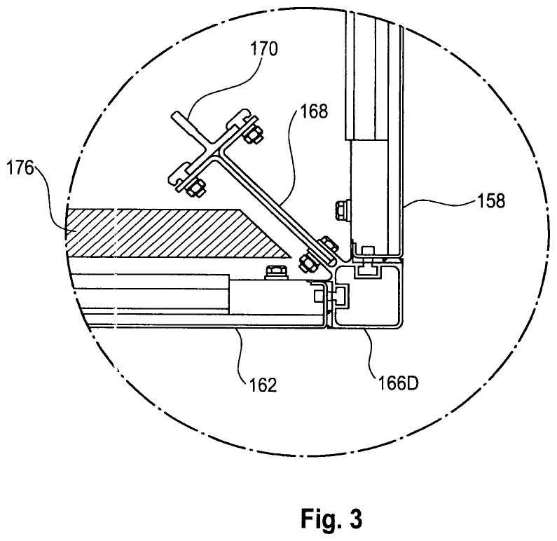

FIG. 3 shows an enlarged view of the corner posts and guide posts of the elevator according to the invention from FIG. 2

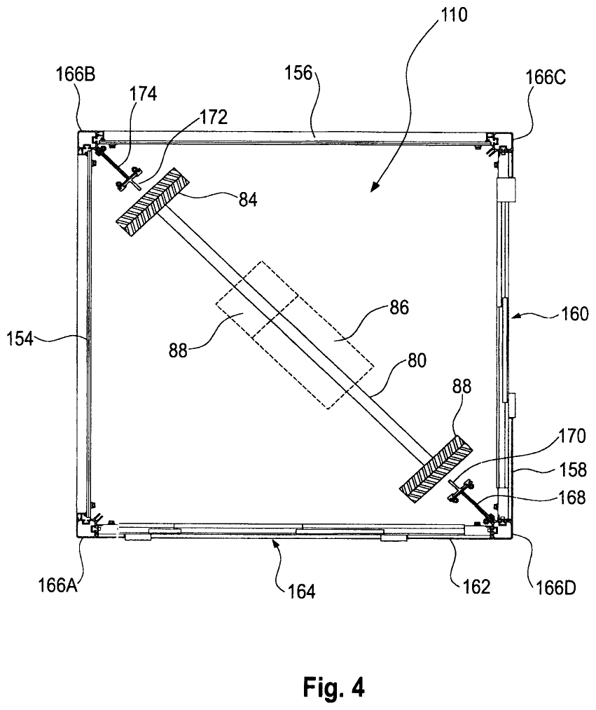

FIG. 4 shows a further horizontal cross-sectional view of an expedient drive unit for the elevator

FIG. 1 shows a schematic perspective overall view of an elevator that may be used in this way within the scope of the present invention. However, a variety of other elevator constructions may also be considered. The elevator comprises the elevator shaft 10, which is preferably erected over a rectangular base, i.e. cuboidal overall. A square base is also expedient. The elevator shaft may be provided by a building, for example cast from concrete, or it may be constructed independently of the building using its own components. For example, an elevator shaft may be made from posts and struts and inserted panels. Such panels may be made of plastic, metal or glass. The elevator shaft may also be configured for retrofitting to an existing building.

The elevator shaft comprises a front wall 12, followed by a lateral wall 14, followed by the rear wall 16 and, opposite the lateral wall 14, the lateral wall 18. In accordance with the shaft configuration, all lateral walls have a substantially rectangular, flat shape. The lateral walls are erected above the base 20.

Access openings are provided in the lateral walls, namely the access opening 22 on a first level in the front wall 12. The access opening 24 is arranged above this in the lateral wall 18. The access opening 26 is provided as a further access opening at a higher level in the front wall 12. The access openings are typically each closed with shaft doors. All access openings may be provided on one side, for example all in the front wall 12, or the access openings may be provided in different lateral walls.

The elevator construction shown here even allows access openings to be provided in all four shaft walls. This is not possible with conventional elevators. However, this option creates a great deal of freedom for architectural form. It may also be decisive in determining whether an elevator may be retrofitted. When retrofitting, often only certain directions of access are possible and it may easily be the case that access on the ground floor has to be from the front, but on an upper floor it is only possible from one side.

The shaft 10 is limited at the top by the ceiling 28. However, it would be perfectly conceivable, particularly within the scope of the present invention, to provide a shaft without a ceiling.

The inner frame 30 is erected inside the shaft 10. Said inner frame consists of a first post 32, which is arranged in one corner of the shaft. The second post 34 is arranged in the diagonally opposite corner of the shaft. The two posts are connected by the cross strut 36, which runs diagonally in the upper region of the shaft. It may run directly below the ceiling 28.

The cross strut 36 may carry various components, symbolically shown here are drive rollers 38A and 38B, which are provided at the ends of the cross strut 36 adjacent to the posts 32 and 34. The cross strut 36 may also carry a drive unit 40. The drive unit 40 will generally comprise an electric motor which may drive the drive rollers 38 by suitable drive means, for example corresponding shafts. Drive rollers are particularly suitable for driving toothed belts, which may raise and lower an elevator car. This will be explained in greater detail below.

FIG. 2 shows a plan-view cross-section of an inner frame and outer frame according to the invention as well as an elevator car adapted thereto. The car 110 comprises the base 112 and also the first car door 140 and the second car door 146.

The base 112 extends within a square, but is not itself square, as the corners of the square are not filled. The car 110 is bounded by a first lateral wall 114 and a second lateral wall 116. The first access opening is located opposite the lateral wall 114. The second access opening is located opposite the second lateral wall 116.

The lateral walls 114 and 116 run towards each other at right angles, but do not touch each other. Rather, a first broad corner 122 is provided in the region where the extensions of the lateral walls would intersect. Opposite, in the region where the directions of the access openings intersect, a second broad corner 124 is provided. A first short corner is provided between the lateral wall 116 and the first access opening. A second short corner is provided between the first lateral wall 14 and the second access opening.

A wall element 132 is provided between the first lateral wall and the second lateral wall 116. The top view shows a broad corner between the lateral walls; from the inside view of the user, simply a further wall element 132 or panel is recognizable. A corresponding wall element 134 is arranged in the second broad corner 124.

Wall elements are also provided in the aforesaid short corners. In the first short corner, this is the wall element 136. In the second short corner, this is the wall element 138.

The first access opening is closed by a first car door 140. The first car door 140 comprises two leaves, namely the first leaf 142 and the second leaf 144. The car door is intended to open towards the second broad corner 124. This means that the first leaf 142 moves over a further distance than the second leaf 144 when opening. The first leaf 142 is therefore usually referred to as the “fast” leaf.

The second access opening is closed by the second car door 146. This car door has three leaves. The car door 146 comprises the third leaf 148 and the fourth leaf 150. It also comprises the fifth leaf 152. The leaves 148 and 150 are also intended to open in the direction of the second broad corner 124. Thus, the fourth wing 150 is the fast wing here. The fifth wing 152 opens in the opposite direction, i.e., towards the second short corner 128. The fifth leaf 152 is considerably shorter than the third leaf 48 and the fourth leaf 50. Alternatively, the second car door may also be designed with four leaves, two of which open in opposite directions.

The embodiment of the car therefore allows short wall panels (such as 132 and 134) and broad corners to be provided without any disadvantage when using the car. These may be advantageously combined with an inner frame.

The car 110 is surrounded by the first shaft wall 154 and the second shaft wall 156. Opposite the first shaft wall 154 is the third shaft wall 158 and the first shaft door 160. Opposite the second shaft wall 156 is the fourth shaft wall 162 and the adjacent second shaft door 164. The elevator car is suitable for shafts of various types, shown here is a shaft that was constructed with corner posts, corner posts 166A, 166B, 166C and 166D are shown. These corner posts are arranged in the corners of a square, so that the shaft has a square base area. As explained, the base 112 is nevertheless not square in shape, but is spaced from the corners of the shaft precisely in the corner areas.

There is therefore space for further devices in the shaft in the broad corners of the car 110. A first guide post 170 is provided here, which is connected to the corner post 166D by a first connecting element 168. A guide post 172 is provided opposite, which is connected to the corner post 166B by the connecting element 174. The guide posts each provide (generally within the scope of the present invention) at least one guide rail. They may also consist solely of a guide rail (e.g. a flat bar) or comprise further elements, e.g., be formed as a T-beam. The guide posts may provide an inner frame. Accordingly, the guide posts are more frequently referred to simply as guide rails. However, it is advantageous if the guide posts are self-supporting elements which at least do not require support by a shaft wall and also if the guide posts are supported on the shaft floor.

FIG. 3 shows an enlarged detail of the shaft structure in the region of the corner post 166D. Such a corner post may be formed as a profiled post. This makes it possible for corresponding shaft walls, such as the third shaft wall 158 and the fourth shaft wall 162, to be well connected to the corner post 166D and to be supported by the corner posts. Corresponding wall portions may easily be made of metal, for example aluminum, plastic or even glass. They may be provided with suitable frames. Grooves may be provided for the corresponding connection. In the case of a shaft post with a substantially square profile, suitable connecting elements will therefore be at right angles.

Additional connecting elements may be provided between these connecting elements, for example at a 45-degree angle. These additional connecting elements may be used for connection to technical components for the shaft. For example, a groove extending at a 45-degree angle is provided here (not described in greater detail) and accommodates the connecting element 168. This connecting element 168 carries the guide post 170.

This enlarged view highlights how the arrangement of corner posts and guide posts creates a region in which the door leaves of the car may be moved in the open position. This region is shown hatched as region 176.

FIG. 4 shows a horizontal section through the shaft 110 of an elevator according to the invention. The shaft construction is already known in substantial parts from FIG. 2. The view is from above onto the shaft floor. The shaft is surrounded by the first shaft wall 154 and the adjacent and vertical second shaft wall 156. Opposite the first shaft wall 154 are the third shaft wall 158 and the first shaft door 160. Opposite the second shaft wall 156 are the fourth shaft wall 162 and the second shaft door 164. The shaft as a whole is embodied with a frame, i.e., suitable for retrofitting an elevator, for example, and is supported by corner posts. The corner posts 166A, 166B, 166C and 166D are recognizable.

Guide posts are provided in two diametrically opposite corners and may be connected to the corner posts by connecting elements. The connecting element 168 connects the guide post 170 to the corner post 166D. The guide post 172 is provided opposite and is connected to the corner post 166B by the connecting element 174.

The guide posts 170 and 172 form the inner frame and correspond to the posts 32 and 34 in the schematic illustration in FIG. 1. The guide posts are formed here as T-beams. They may not only support a cross strut in their upper region, but also serve to guide the car along its length. Accordingly, the base of the T-beam points towards the inside of the shaft.

The view is of the drive elements in the upper shaft region. The shaft 80 may be seen there, which drives the first drive wheel 82 and the second drive wheel 84. A drive motor 86 for driving the shaft is shown schematically. Also shown schematically is a transmission 88, which, however, may also be omitted in the context of the present invention. In general, it is quite possible within the scope of the present invention to position drive elements such as the drive motor or also electrical switch boxes below the shaft ceiling provided by the outer frame.

The shaft 80 is oriented exactly along the connecting line of the guide posts 170 and 172. It may therefore be easily supported by the guide posts themselves or a cross strut attached thereto. This orientation of a drive shaft is generally preferred in the context of the present invention.

All in all, it is possible to see how an elevator may be constructed efficiently and ecologically, which may be used in a variety of ways and may also be easily retrofitted.

### List of Reference Signs

10 Shaft
12 Front wall
14 Lateral wall
16 Rear wall
18 Lateral wall
20 Base
22 Access opening
24 Access opening
26 Access opening
28 Ceiling
30 Inner frame
32 First post
34 Second post
36 Cross strut
38 Drive shaft
40 Drive
[ . . . ]
80 Drive shaft
82 First drive wheel
84 Second drive wheel
86 Motor
88 Transmission unit
[ . . . ]
110 Car
112 Base
114 First lateral wall
116 Second lateral wall
118 First access opening
120 Second access opening
122 First broad corner
124 Second broad corner
126 First short corner
128 Second short corner
130 Control element
132 Wall element
134 Wall element
136 Wall element
138 Wall element
140 First car door
142 First leaf
144 Second leaf
146 Second car door
148 Third leaf
150 Fourth leaf
152 Fifth leaf
154 First shaft wall
156 Second shaft wall
158 Third shaft wall
160 First shaft door
162 Fourth shaft wall
164 Second shaft door
166 Corner post
168 Connecting element
170 Guide post
172 Guide post
174 Connecting element

1. An elevator comprising a car, an inner frame and an outer frame, wherein the outer frame encloses an elevator shaft and comprises a base plate, a first lateral surface, a second lateral surface lying opposite the first lateral surface, a third lateral surface, and a fourth lateral surface lying opposite the third lateral surface, wherein the inner frame comprises at least one first guide post and a second guide post lying opposite the first guide post, wherein the inner frame supports the weight of the car, and wherein the first guide post and the second guide post are arranged diagonally opposite each other at the edge of the base plate, over which the outer frame is erected.

2. The elevator according to claim 1, wherein the lateral surfaces are arranged on a rectangle.

3. The elevator according to claim 1, wherein the inner frame also carries the drive unit.

4. The elevator according to claim 1, wherein the inner frame also carries two drive rollers.

5. The elevator according to a claim 1, wherein the first guide post is connected to the outer frame by at least one spacer element.

6. The elevator according to claim 1, wherein the spacer element is configured to bridge a length of at least 2 cm.

7. The elevator according to claim 1, wherein the first guide post and the second guide post are connected by a cross strut.

8. The elevator according to claim 7, wherein a drive shaft is provided parallel to the cross strut.

9. The elevator according to claim 1, wherein at least the first guide post consists substantially of a T-beam.

10. The elevator according to claim 1, wherein at least the first guide post is substantially made of steel.

11. The elevator according to claim 1, wherein the outer frame is substantially made of aluminum.

12. The elevator according to claim 1, wherein the outer frame comprises four corner posts.

13. The elevator according to claim 12, wherein at least one corner post of the four corner posts has lateral surfaces arranged around a rectangular cross-section and a groove arranged at a 45-degree angle to the lateral surfaces.
